(19) United States
(12) Patent Application Publication
(10) Pub. No.: US 2018/0213108 A1
(43) Pub. Date: Jul. 26, 2018

(54) METHOD FOR EXTRACTING DATA FROM A NON-DIGITAL MEDIUM AND TRANSFERRING DATA

(71) Applicant: Evolved Data Solutions LLC, Richfield, NC (US)

(72) Inventors: Alexander Stewart Grubb, Concord, NC (US); Stewart Dean Grubb, Denton, NC (US)

(21) Appl. No.: 15/416,493

(22) Filed: Jan. 26, 2017

(51) Int. Cl. H04N 1/21; H04N 1/32; H04N 1/40; H04N 1/00; G06Q 40/08

(52) U.S. Cl. CPC H04N 1/217; H04N 1/32475; H04N 1/40012; H04N 1/00331; H04N 2201/0098; H04N 2201/0084; H04N 2201/0089; H04N 2201/0068; G06Q 40/08

(57) ABSTRACT

A system for and a method of extracting data from a non-digital medium and having the ability to move the derived (digitized) data, said method comprising: collecting desired information or applicable data in the form of text, picture, or any other type of file with readable text; and digitizing the desired information or applicable data into digitized data to form a digital image; and rendering the digitized data onto a digital canvas as interactive text.

### FIELD OF THE INVENTION

Extracting data from a non-digital medium and having the ability to move the derived (digitized) data, including digitizing the desired information.

### BACKGROUND OF THE INVENTION

Data transmission is the physical transfer of data over a point-to-point or point-to-multipoint communication channel. Examples of such data transmission include manually extracting data from a non-digital medium such as a report and transferring the data to a system, such as a computer system, remote or centralized.

Manual data transmission is time consuming and generally results in errors and/or missed data. A need exists for data transmission that is faster and error free.

### SUMMARY OF THE INVENTION

Accordingly, methods and apparatuses, intended to address at least the above-identified concerns, would find utility.

The following is a non-exhaustive list of embodiments, which may or may not be claimed, of the subject matter according the present disclosure.

One embodiment of the present disclosure relates to a method of extracting data from a non-digital medium and having the ability to move the derived (digitized) data, the method comprising; collecting desired information or applicable data, regarding a matter in the form of text, picture, or any other type of file with readable text; digitizing the desired information or applicable data into digitized data; and rendering the digitized data onto a digital canvas as interactive text.

Another embodiment of the present disclosure relates to a system for extracting data from a non-digital medium and having the ability to move the derived (digitized) data, the system comprising (a) desired information or applicable data; (b) means for saving the desired information or applicable data in the form of text, picture, or any other type of file with readable text; (c) a system where in the desired information or applicable data is uploaded into the system for processing, image generation and data extraction, resulting in digitized data, wherein the system can read the digitized data; and (d) means for rendering the digitized data onto a digital canvas as interactive text.

### BRIEF DESCRIPTION OF THE DRAWINGS

Having thus described embodiments of the present disclosure in general terms, reference will now be made to the accompanying drawing, which are not necessarily drawn to scale, and wherein like reference characters designate the same or similar parts throughout the several views, and wherein:

FIG. 1 is a block diagram of a method of extracting data from a non-digital medium and having the ability to move the derived (digitized) data.

### DETAILED DESCRIPTION OF THE INVENTION

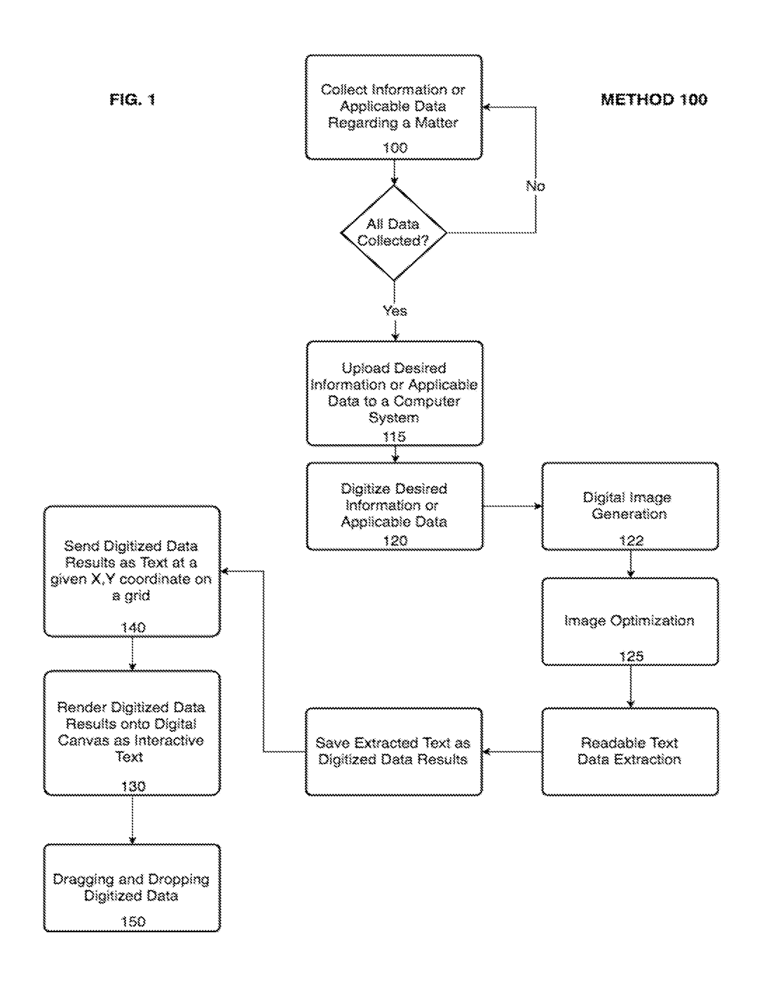

In FIG. 1 referred to above, solid lines, connecting various elements and/or components may represent components thereof. It will be understood that not all relationships among the various disclosed elements are necessarily represented. One or more elements shown in solid and/or dashed lines may be omitted from a particular example without departing from the scope of the present disclosure. Those skilled in the art will appreciate that some of the features illustrated in FIG. 1 may be combined in various ways without the need to include other features described in FIG. 1, and/or the accompanying disclosure, even though such combination or combinations are not explicitly illustrated herein. Similarly, additional features not limited to the examples presented, may be combined with some or all of the features shown and described herein.

The method 100 of the present disclosure relates to a method of extracting data from a non-digital medium and having the ability to move the derived (digitized) data, the method comprising; a) collecting desired information or applicable data, regarding a matter in the form of text, picture, or any other type of file with readable text 110; b) digitizing the desired information or applicable data into digitized data 120; and c) rendering the digitized data onto a digital canvas as interactive text 130.

The method 100 of the present disclosure further relates to a method of extracting data from a non-digital medium and having the ability to move the derived (digitized) data, wherein step a) includes collecting desired information or applicable data, regarding a matter in the form of text, picture, or any other type of file with readable text, 110, wherein such collecting can involve person to person exchange wherein one person collects pertinent information from another person. The desired information or applicable data comprises typed or handwritten text. The readable text in the file is selected from pdf, pic, jpeg, tif, image format file, document format file, or any other file. In one embodiment, the collected desired information or applicable data may be saved into a file on an insurance agent's computer 115. In addition the desired information or applicable data can be saved on a flash drive, document folder, or CD.

Such collection can be based on directly speaking to a person in person or on the telephone or via a computer, etc. Such information may include personal information, information about vehicles, housing, businesses, equipment, or numerous other articles or pertinent information. Such collection is generally done in a manual manner.

In another embodiment, the method 100 of the present disclosure further relates to a extracting data from a non-digital medium and having the ability to move the derived (digitized) data 100, wherein step b) includes digitizing the desired information or applicable data into digitized data 120. Digitization is the process of converting the desired information or applicable data into a digital format. In this format, the desired information or applicable data is organized into discrete units of data (called bit s) that can be separately addressed (usually in multiple-bit groups called bytes). In particular, digitization is the representation of an object, image, or a document by generating a series of numbers that describe a discrete set of its points or samples. The result is called a digital image, for the object, and digital form, for the signal. Preferably, the digitized data is in the form of binary numbers, which facilitate computer processing and other operations, but strictly speaking, digitizing simply means the conversion of analog source material into a numerical format.

In another embodiment, the method 100 of the present disclosure further relates to a extracting data from a non-digital medium and having the ability to move the derived (digitized) data 100, wherein step b) comprises converting the image form into monochromatic color palette to optimize the image 125. This conversion makes internal character matching decisions easier.

In another embodiment, the method 100 of the present disclosure further relates to a extracting data from a non-digital medium and having the ability to move the derived (digitized) data 100, wherein step c) includes rendering the digitized data onto a digital canvas as interactive text 130. Interactive text generally refers to products and services on digital computer-based systems which respond to the user's actions by presenting content such as text or images. This step includes converting the image into monochromatic color palette, which makes internal character matching decisions easier. Manipulating the image of step c) includes uploading the desired information or applicable data into a system 115 and digitizing the desired information or applicable data into digitized data 122, wherein the system can read the digitized data. In one embodiment, the document that holds the desired information or applicable data is clicked on from the desired saving place on the computer and is the dragged into a computer system that is accessed online through any internet browser via a website. In addition, step c) may include overlaying the original document.

The document that holds the desired information is clicked on from the desired saving place on the computer and is the dragged into our system that is accessed online through any internet browser via our website.

In another embodiment, the method 100 of the present disclosure further relates to a extracting data from a non-digital medium and having the ability to move the derived (digitized) data 100, wherein the desired information or applicable data comprises typed text.

In another embodiment, the method 100 of the present disclosure further relates to a extracting data from a non-digital medium and having the ability to move the derived (digitized) data 100, wherein manipulating the image of step d) of removing artifacts from the image that would inhibit the accuracy of the Optical Character Recognition (OCR) engine.

In another embodiment, the method 100 of the present disclosure further relates to a extracting data from a non-digital medium and having the ability to move the derived (digitized) data, wherein manipulating the image of step e) including dragging and dropping the desired information or applicable data into a input field 150, such as a text box or a combo box. Step e) may include creating a box around the typed text to move multiple words at one time.

In another embodiment, the method 100 of the present disclosure further relates to a extracting data from a non-digital medium and having the ability to move the derived (digitized) data 100, further comprising step f) of presenting an UI select region of the system customer file to recognize; and submitting the UI select region of the system customer file one-by-one to the backend API server for processing. The extraction of data from a non-digital medium and having the ability to move the derived (digitized) data can be done all of the data at once and/or in smaller units of the data at a time.

In another embodiment, the method 100 of the present disclosure further relates to a extracting data from a non-digital medium and having the ability to move the derived (digitized) data 100, further comprising g) sending digitized data from the server as text at a given X, Y coordinate on a grid 140.

In another embodiment, the method 100 of the present disclosure further relates to a extracting data from a non-digital medium and having the ability to move the derived (digitized) data 100, further comprising presenting an User Interface (UI) select region of the system customer file to recognize; and submitting the UI select region of the system customer file one-by-one to the backend Application Program Interface (API) server for processing. A server-side web API is a programmatic interface consisting of one or more publicly exposed endpoints to a defined request-response message system, typically expressed in JSON or XML, which is exposed via the web—most commonly by means of an HTTP-based web server.

In another embodiment, the method 100 of the present disclosure further relates to a extracting data from a non-digital medium and having the ability to move the derived (digitized) data 100, wherein the desired information or applicable data comprises typed text on it.

In another embodiment, the method 100 of the present disclosure further relates to a extracting data from a non-digital medium and having the ability to move the derived (digitized) data 100, wherein the desired information or applicable data is insurance data.

A system for extracting data from a non-digital medium and having the ability to move the derived (digitized) data, the system comprising a) desired information or applicable data regarding a matter; b) means for saving the desired information or applicable data in the form of text, picture, or any other type of file with readable text; c) a system where in the desired information or applicable data is uploaded into the system for processing, image generation and data extraction, resulting in digitized data, wherein the system can read the digitized data; and d) means for rendering the digitized data onto a digital canvas as interactive text.

In another embodiment, the system of the present disclosure further relates to extracting data from a non-digital medium and having the ability to move the derived (digitized) data, wherein the system includes a) desired information or applicable data regarding a matter. The desired information or applicable data comprises typed or handwritten text. Such collection can be based on directly speaking to a person, collecting information on the computer, etc. Such information may include personal information, information about vehicles, housing, businesses, equipment, or numerous other articles or pertinent information. Such collection is generally done in a manual manner. The readable text in the file is selected from pdf, pic, jpeg, tif, image format file, document format file, or any other file. In one embodiment, the collected desired information or applicable data may be saved into a file on an insurance agent's computer.

In another embodiment, the system of the present disclosure further relates to extracting data from a non-digital medium and having the ability to move the derived (digitized) data, wherein the system includes a means b) for saving the desired information or applicable data in the form of text, picture, or any other type of file with readable text. The means for saving is generally a computer system.

In another embodiment, the system of the present disclosure further relates to extracting data from a non-digital medium and having the ability to move the derived (digitized) data, wherein manipulating the image of step c) wherein the desired information or applicable data is uploaded into the system for processing, image generation and data extraction, resulting in digitized data, wherein the system can read the digitized data. In particular, the system can read the digitized data converting the image into monochromatic color palette.

In another embodiment, the system of the present disclosure further relates to extracting data from a non-digital medium and having the ability to move the derived (digitized) data, includes part d), the means for rendering the digitized data onto a digital canvas as interactive text. Interactive text generally refers to products and services on digital computer-based systems which respond to the user's actions by presenting content such as text or images. This step includes converting the image into monochromatic color palette, which makes internal character matching decisions easier. Manipulating the image of step c) includes uploading the desired information or applicable data into a system and digitizing the desired information or applicable data into digitized data, wherein the system can read the digitized data. In addition, step c) may include overlaying the original document. A computer system may be used for rendering the digitized data onto a digital canvas as interactive text.

In another embodiment, the system of the present disclosure further relates to extracting data from a non-digital medium and having the ability to move the derived (digitized) data, wherein artifacts are removed from the image that would inhibit the accuracy of the OCR engine. The extraction of data from a non-digital medium and having the ability to move the derived (digitized) data can be done all of the data at once and/or in smaller units of the data at a time.

In another embodiment, the system of the present disclosure further relates to extracting data from a non-digital medium and having the ability to move the derived (digitized) data, further comprising e) presenting an UI select region of the system customer file to recognize; and submitting the UI select region of the system customer file to the backend API server for processing. The extraction of data from a non-digital medium and having the ability to move the derived (digitized) data can be done all of the data at once and/or in smaller units of the data at a time.

In another embodiment, the system of the present disclosure further relates to extracting data from a non-digital medium and having the ability to move the derived (digitized) data, wherein the digitized data is sent from the server as text at a given X, Y coordinate on a grid.

In another embodiment, the system of the present disclosure further relates to extracting data from a non-digital medium and having the ability to move the derived (digitized) data, wherein the desired information or applicable data comprises typed text.

In another embodiment, the system of the present disclosure further relates to extracting data from a non-digital medium and having the ability to move the derived (digitized) data, wherein the typed text in the file is selected from pdf, pic, jpeg, tif, image format file, document format file, or any other file.

In another embodiment, the system of the present disclosure further relates to extracting data from a non-digital medium and having the ability to move the derived (digitized) data, wherein a box is created around the typed text to move multiple words at one time.

In another embodiment, the system of the present disclosure further relates to extracting data from a non-digital medium and having the ability to move the derived (digitized) data further comprises f) a movant means to move the information or applicable data into a system. The movant means may include a mouse, cursor, stylus, finger, or pen for example.

In another embodiment, the system of the present disclosure further relates to extracting data from a non-digital medium and having the ability to move the derived (digitized) data, wherein the movant means f) comprises dragging and dropping the desired information or applicable data into a computer system.

In another embodiment, the system of extracting data from a non-digital medium and having the ability to move the derived (digitized) data wherein the data is insurance data.

Different embodiments of the method(s) and system(s) disclosed herein include a variety of components, features, and functionalities. It should be understood that the various embodiments of the method(s) and system(s) disclosed herein may include any of the components, features, and functionalities of any of the other embodiments of the method(s) and system(s) disclosed herein in any combination, and all of such possibilities are intended to be within the spirit and scope of the present disclosure.

Many modifications of embodiments set forth herein will come to mind to one skilled in the art to which the present disclosure pertains having the benefit of the teachings presented in the foregoing descriptions and the associated drawings.

Therefore, it is to be understood that the present disclosure is not to be limited to the specific embodiments illustrated and that modifications and other embodiments are intended to be included within the scope of the appended claims. Moreover, although the foregoing description and the associated drawings describe embodiments of the present disclosure in the context of certain illustrative combinations of elements and/or functions, it should be appreciated that different combinations of elements and/or functions may be provided by alternative implementations without departing from the scope of the appended claims. Accordingly, parenthetical reference numerals in the appended claims are presented for illustrative purposes only and are not intended to limit the scope of the claimed subject matter to the specific embodiments provided in the present disclosure.

What is claimed is:

1. A method of extracting data from a non-digital medium and having the ability to move the derived (digitized) data, said method comprising:
a. collecting desired information or applicable data in an image form of text, picture, or any other type of file with readable text;
b. digitizing the desired information or applicable data into digitized data to form a digital image; and
c. rendering the digitized data onto a digital canvas as interactive text.

2. The method of claim 1, wherein step b) comprises converting the image form into monochromatic color palette.

3. The method of claim 1, wherein the desired information or applicable data comprises typed or handwritten text.

4. The method of claim 1, wherein the readable text in the file is selected from pdf, pic, jpeg, tif, image format file, document format file, or any other file.

5. The method of claim 1, further comprising step d) removing artifacts from the image that would inhibit accuracy of an Optical Character Recognition (OCR) engine which occurs prior to step b).

6. The method of claim 1, further comprises step e) of dragging and dropping the desired information or applicable data into an input field.

7. The method of claim 6, wherein step e) includes creating
a box around the interactive text to select multiple results at one time.

8. The method of claim 1, further comprising step f) sending digitized data from a server as text at a given X, Y coordinate on a grid before step c).

9. The method of claim 1, further comprises step g) uploading the desired information or applicable data into a computer system after step a).

10. The method of claim 1, wherein the desired information or applicable data is insurance data.

11. A system for extracting data from a non-digital medium and having the ability to move the derived (digitized) data, the system comprising:
(a) desired information or applicable data;
(b) means for saving the desired information or applicable data in an image form of text, picture, or any other type of file with readable text;
(c) a system where in the desired information or applicable data is uploaded into the system for processing, image generation and data extraction, resulting in digitized data, wherein the system can read the digitized data; and
(d) means for rendering the digitized data onto a digital canvas as interactive text.

12. The system of claim 11, wherein digitized data is comprises monochromatic color palette.

13. The system of claim 11, wherein manipulating the image of (c) comprises converting the generated image of the desired information or applicable data into a monochromatic color palette.

14. The system of claim 11, wherein artifacts are removed from the image that would inhibit the accuracy of the OCR engine.

15. The system of claim 11, wherein the digitized results are sent from the system as text at a given X, Y coordinates on a grid.

16. The system of claim 11, wherein the desired information or applicable data comprises typed or handwritten text.

17. The system of claim 16, wherein the readable text in the file is selected from pdf, pic, jpeg, tif, image format file, document format file, or any other file.

18. The system of claim 11, wherein the system further comprises (e) a movant means to move the information or applicable data into a system.

19. The system of claim 11 wherein the desired information or applicable data is insurance data.
